(19) United States
(12) Patent Application Publication
(10) Pub. No.: US 2011/0235527 A1
(43) Pub. Date: Sep. 29, 2011

(54) MULTICHANNEL CONTROLLER MODULE

(75) Inventors: Rolf Buse, Uhldingen-Muhlhofen (DE); Benno Petersen, Herdwangen (DE); Jorg Wolfrum, Markdorf (DE)

(73) Assignee: DIEHL AEROSPACE GMBH, Ueberlingen (DE)

(21) Appl. No.: 13/133,264

(22) PCT Filed: Nov. 25, 2009
(86) PCT No.: PCT/EP09/08372

§ 371 Date: Jun. 7, 2011

(30) Foreign Application Priority Data
Dec. 16, 2008 (DE) 10 2008 052 594.9

(51) Int. Cl. H04L 12/26

(52) U.S. Cl. 370/242

(57) ABSTRACT

The invention relates to a multichannel controller module for integrated modular avionics, having at least two channels,
wherein, in each of the channels, at least one first interface, which is intended for communication with a control computer, a processor, at least one second interface, which is intended for communication with a peripheral, and a first memory, which is provided with an operating system, are connected in order to interchange data with one another,
wherein a second memory is provided for selective storage of at least one application program for communication with the peripheral,
wherein a selection means is provided, by means of which the application program is selectively assigned a first or a second mode of operation,
wherein the first mode of operation is a redundant duplex mode of operation, in which both channels are used to execute the application program, and the two channels are in this case connected to one another via a data interchange and fault monitoring means, and
wherein the second mode of operation is a non-redundant simplex mode of operation, in which only one of the two channels is used to .execute the application program, and the data interchange and fault monitoring means is in this case deactivated.

The invention relates to a multichannel controller module for integrated modular avionics (IMA).

According to the prior art, U.S. Pat. No. 5,406,472 discloses a multichannel controller module having two channels, wherein an interface, a processor and a first memory are connected to one another for data interchange in each of the channels. The two channels are operated using a redundant duplex operating mode, in which both channels are used to execute a fixed predetermined program, and the two channels are connected to one another via a data interchange and fault monitoring means. If the data interchange and fault monitoring means detects a fault, the channel which is operating incorrectly is deactivated.

EP 0 435 613 A2 discloses a further multichannel controller module. In this case, at least one interface, which is intended for communication with a control computer, a processor, at least one second interface, which is intended for communication with a peripheral, and a memory for data interchange are connected to one another in each of the channels. This multichannel controller module is also operated in a redundant duplex operating mode, in which both channels are connected to one another via a data interchange and fault monitoring means.

The known multichannel controller modules are normally matched by the manufacturer to the specific functions to be carried out by them, for example open-loop and closed-loop control of an aircraft turbine or the like. In this case, they are normally accommodated in the cockpit of an aircraft, in conjunction with the avionics provided there. Relatively recently, a change has been made, in order to increase the performance of the avionics, namely to distribute said modules so as to be physically separate from one another, in the aircraft. In particular, controllers are nowadays accommodated in the vicinity of the sensors and/or actuators connected to them, and are connected via a bus system to a central control computer, which is provided in the cockpit. Controllers such as these, which are accommodated remotely from the control computer, are also referred to as remote controller electronics (RCE).

At the moment, the RCE is specific for the peripheral to be operated by it, for example sensors or actuators. In consequence, they have to be implemented in the software architecture of the avionics. The functional processes of the RCE disadvantageously differ—even if they have to satisfy specific quality requirements. This makes it difficult to find a fault. In addition, the avionics are therefore more susceptible to make functions overall.

The object of the invention is to overcome the disadvantages according to the prior art. One particular aim is to specify a multichannel controller module, which is as universal as possible, for integrated modular avionics, which makes it possible to comply with an improved safety standard.

This object is achieved by the features of claim 1. Expedient refinements of the invention will become evident from the features of claims 2 to 10.

According to the invention, provision is made for the first memory in a multichannel controller module to comprise an operating system. This is expediently a multilayer operating system in which the lower layers are not directly accessible for a user, that is to say for the manufacturer of an application program. In particular, fault identification, fault assessment and/or fault correction routines can be provided in the lower layers of the operating system.

The multichannel controller module furthermore comprises a second memory for selective storage of at least one application program for communication with the peripheral. In this context, it is, of course, also possible to store different application programs for communication with different peripherals.

Furthermore, according to the invention, a selection means is provided, by means of which a first or a second mode of operation is selectively assigned to the application program. The selection means is expediently a program section of the operating system. By way of example, a user-friendly user interface can be provided for selection of the mode of operation. The first mode of operation is a redundant duplex mode of operation, in which both channels are used to execute the application program, and the two channels are in this case connected to one another via a data interchange and fault monitoring means. In this case, the same input is available to both channels at the same time. If the data interchange and fault monitoring means finds that there is a fault in one of the two channels, this channel can be deactivated depending on the nature of the fault. It is also possible to tolerate certain faults or else, depending on the nature of the fault, to deactivate both channels. The first mode of operation is in general assigned to those application programs which are critical to flight safety.

In addition, according to the invention, the selection means can also be used, however, to assign a second mode of operation to the application program. This is a non-redundant simplex mode of operation, in which only one of the two channels is used to execute the application program, and the data interchange and fault monitoring means is in this case deactivated. In this case, only the input of the channel assigned to it is available to the application program. The second mode of operation is preferably assigned to those application programs which are not critical for flight safety.

The proposed multichannel controller module is particularly universal. This for the first time provides a standardized platform, by means of which an application program can be selectively operated in a particularly safe first operating mode or in a second operating mode.

According to one advantageous refinement, a first configuration means is provided for configuration of the first interface. The first interface may comprise a CAN interface or a FlexRay interface. The first configuration means allows a manufacturer of the application program to easily configure the first interface to match the requirements of the application program. There is no longer any need for complex programming of the first interface. In a similar manner, a second configuration means can be provided for configuration of the second interface. This allows the second interface to be configured quickly and easily by the manufacturer of the application program.

In particular, the first and/or second configuration means can be used to configure the parameters and/or the functions of the first and/or second interface. By way of example, these are further program sections of the operating system, by means of which the input parameters and/or functions are transferred to a program, implemented in the operating system, for controlling the interface.

Furthermore, the multichannel controller module may have a plurality of power supply connections and a third configuration means for configuration of the electrical connections. In order to ensure high functional reliability, it is therefore possible to connect the multichannel controller module to a plurality of independent electrical power sources at the same time. The third configuration means makes it possible for the manufacturer of an application program to determine whether, for example in the event of failure of one of the electrical power sources, access should or should not be made to a further electrical connection in order to continue to operate it. In a similar manner to the first and/or second configuration means, the third configuration means may also be a program section of the operating system.

The peripheral may expediently comprise at least one actuator and/or at least one sensor. The actuator may be an electrical switching means, an electromechanical, hydraulic or pneumatic actuator means, or the like. In particular, each channel may comprise at least one, preferably four, digital signal processors for detection and evaluation of signals from the at least one sensor. This allows a high processing speed. Expediently, the proposed multichannel controller module can be used to operate a first application program in the first operating mode and a second application program in the second operating mode, at the same time. Three or more application programs can also be operated on the multichannel controller module at the same time.

According to a further advantageous refinement, a synchronization means is provided for synchronization of the data processing in both channels. The synchronization means is activated in the first operating mode, and is deactivated in the second operating mode. The provision of the synchronization means ensures particularly fast and operationally reliable operation of the fault monitoring means.

Exemplary embodiments of the invention will be explained in more detail in the following text with reference to the drawings, in which:

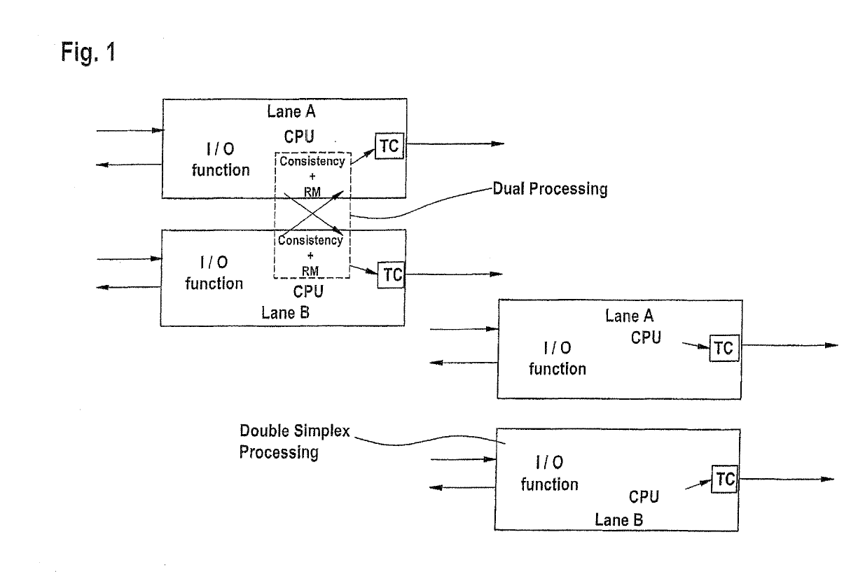

FIG. 1 schematically illustrates a first operating mode “dual processing” and a second operating mode “double simplex processing” of a multichannel controller module,

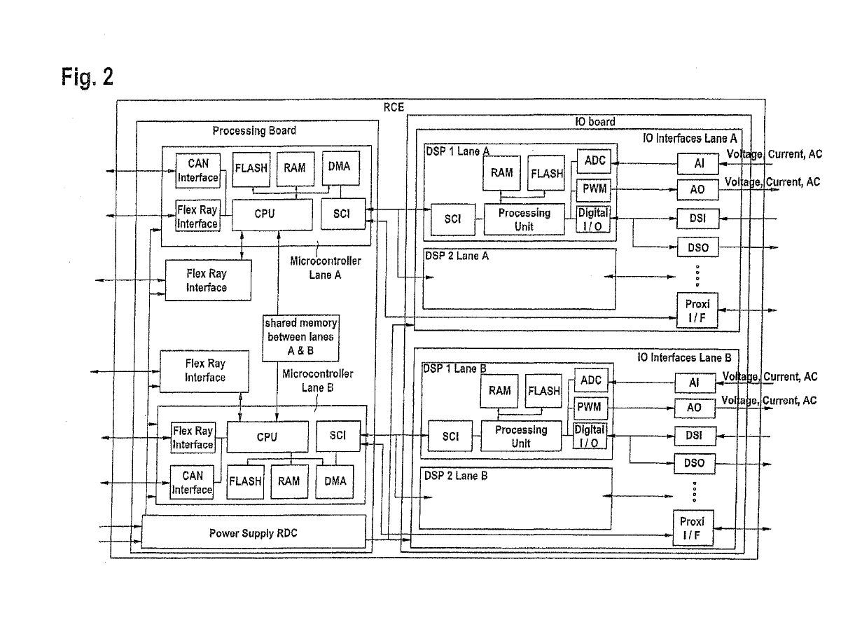

FIG. 2 schematically illustrates the hardware architecture of the multichannel controller module,

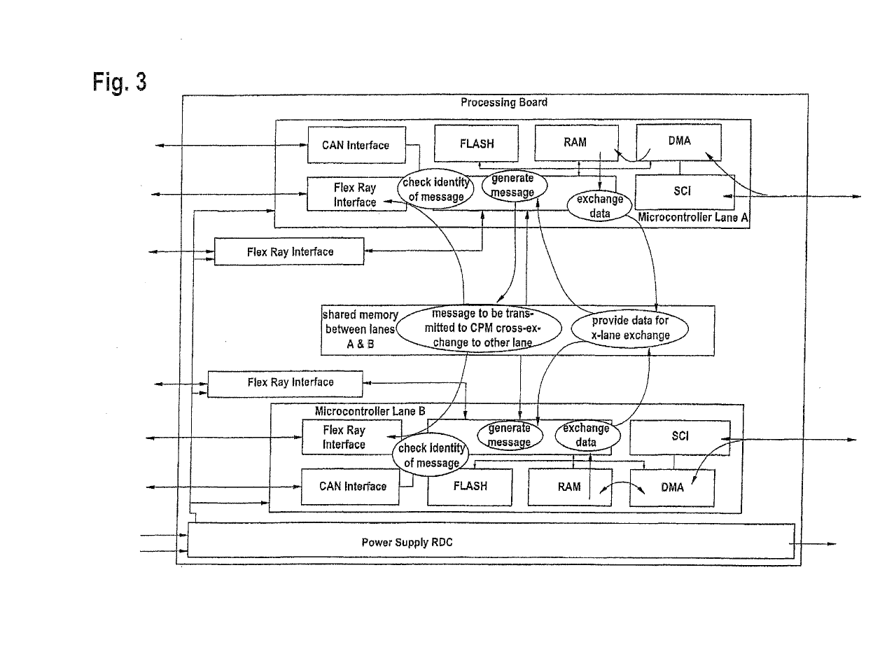

FIG. 3 shows the function of the “Shared Memory” shown in FIG. 2,

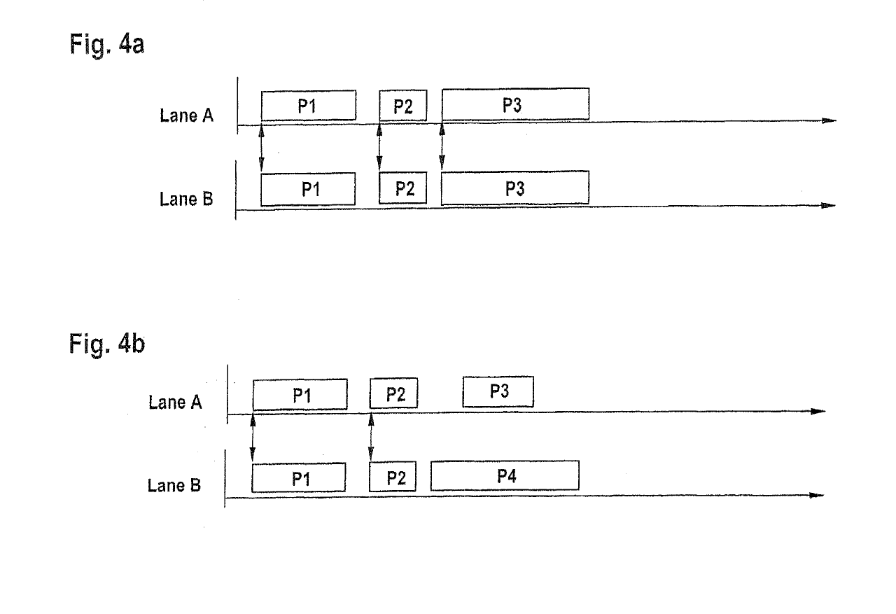

FIG. 4a schematically illustrates the simultaneous operation of a plurality of application programs in the first operating mode, and

FIG. 4b schematically illustrates the simultaneous operation of a plurality of application programs in the first and second operating modes.

FIG. 1 schematically illustrates a multichannel controller module having two channels “Lane A” and “Lane B”. Each of the channels “Lane A” and “Lane B” has a first interface with an input/output function or I/O function, as well as a processor “CPU” and a second interface “TC”. In a first operating mode “dual processing”, both channels “Lane A” and “Lane B” are connected to one another, in order to interchange data alternately. The two channels “Lane A” and “Lane B” mutually monitor the respectively processed data for consistency. In the second operating mode “double simplex processing”, which is also illustrated in FIG. 1, the two channels “Lane A” and “Lane B” are separated from one another. No data is interchanged between the two channels “Lane A” and “Lane B” for fault identification purposes.

FIG. 2 schematically illustrates the hardware architecture of the multichannel controller module “RCE”. This is subdivided into a “processing board”, on which a microcontroller with the “CPU” is accommodated for each of the channels “Lane A” and “Lane B”. A first interface in this case comprises a “CAN Interface” as well as “FlexRay interfaces”. A first memory comprises “FLASH”, “RAM” and “DMA”. In order to communicate with an input/output unit or “IO Board” which accommodates a second interface for each of the channels “Lane A” and “Lane B” an SCI (=Serial Communication Interface) is provided. The processing board furthermore comprises a power supply unit “Power Supply RDC”, which may be provided with a plurality of electrical connections.

As can be seen from FIG. 2, the microcontrollers for the two channels “Lane A” and “Lane B” can be connected to one another via a joint memory unit “Shared Memory”. The IC board of each of the channels “Lane A” and “Lane B” furthermore comprises a digital signal processor unit “DSP”, which in turn comprises a further processor (processing unit) and a further memory. The second interfaces of each of the channels “Lane A” and “Lane B” are annotated with the reference symbol “AL”, “AO”, “DSI”, “DSO”.

FIG. 3 shows the function of the “Shared Memory”. In the first operating mode, that is to say in the duplex mode, the “Shared Memory” allows data to be interchanged alternately between the two channels “Lane A” and “Lane B”. In this case, a predetermined routine is used to check whether the two channels “Lane A” and “Lane B” are operating correctly. If this is not the case, a channel which is operating incorrectly can be switched off. It is also possible to deactivate both channels in this case.

FIGS. 4a and 4b show possible ways to operate a plurality of application programs P1, P2, P3, P4 on the multichannel controller module according to the invention. In the examples shown in FIG. 4a, three application programs P1, P2, P3 are each operated synchronously in the duplex mode.

In the example shown in FIG. 4b, only the application programs P1 and P2 are operated, in each case synchronously in the duplex mode while, in contrast, the further application programs P3 and P4 are operated independently of one another in the simplex mode. This means that the first channel “Lane A” is assigned exclusively to the application program P3, and the second channel “Lane B” is assigned exclusively to the further application program P4.

The proposed multichannel controller module allows application programs to be operated which are critical for flight safety. Application programs such as these may be operated in a duplex operating mode. In this case, however, the data interchange and fault monitoring routines which are required between the channels “Lane A” and “Lane B” are not predetermined by the application program, but by the operating system. Application programs which are not critical for flight safety can be operated selectively in the simplex operating mode, in order to save system resources. A selection means or a program section is available for selection of the respective operating mode, by means of which the duplex or simplex operating mode can be assigned to the respective application program. The proposed configuration means according to the invention, which may be further program sections of the operating system, make it possible for the manufacturer of application programs to configure the interfaces and electrical connections in a simple and convenient manner.

1. A multichannel controller module for integrated modular avionics, having at least two channels,
wherein, in each of the channels, at least one first interface, which is intended for communication with a control computer, a processor, at least one second interface, which is intended for communication with a peripheral, and a first memory, which is provided with an operating system, are connected in order to interchange data with one another,
wherein a second memory is provided for selective storage of at least one application program for communication with the peripheral,
wherein a selection means is provided, by means of which the application program is selectively assigned a first or a second mode of operation,
wherein the first mode of operation is a redundant duplex mode of operation, in which both channels are used to execute the application program, and the two channels are in this case connected to one another via a data interchange and fault monitoring means, and
wherein the second mode of operation is a non-redundant simplex mode of operation, in which only one of the two channels is used to execute the application program, and the data interchange and fault monitoring means is in this case deactivated.

2. The multichannel controller module as claimed in claim 1, wherein a first configuration means is provided for configuration of the first interface.

3. The multichannel controller module as claimed in claim 1, wherein the first interface comprises a CAN interface or a FlexRay interface.

4. The multichannel controller module as claimed in claim 1, wherein a second configuration means is provided for configuration of the second interface.

5. The multichannel controller module as claimed in claim 1, wherein the parameters and/or the function of the first and/or second interface can be configured by means of the first and/or second configuration means.

6. The multichannel controller module as claimed in claim 1, wherein a plurality of power supply connections and a third configuration means for configuration of the electrical connections are provided.

7. The multichannel controller module as claimed in one of the claim 1, wherein the peripheral comprises at least one actuator and/or at least one sensor.

8. The multichannel controller module as claimed in claim 1, wherein each channel comprises at least one, preferably four, digital signal processors.

9. The multichannel controller module as claimed in one claim 1, wherein a first application program can be operated in the first operating mode, and a second application program can be operated in the second operating mode, at the same time.

10. The multichannel controller module as claimed in claim 1, wherein a synchronization means is provided for synchronization of the data processing of both channels, and wherein the synchronization means is activated in the first operating mode and is deactivated in the second operating mode.
